(19) United States
(12) Patent Application Publication
(10) Pub. No.: US 2025/0129869 A1
(43) Pub. Date: Apr. 24, 2025

(54) MANIFOLD

(71) Applicants: Hyundai Motor Company, Seoul (KR); Kia Corporation, Seoul (KR)

(72) Inventors: Jong Cheon Kim, Hwaseong-si (KR); Jin Woo So, Hwaseong-si (KR); Myeong Seok Kim, Hwaseong-si (KR); Jae Jun Lee, Hwaseong-si (KR)

(21) Appl. No.: 18/911,399

(22) Filed: Oct. 10, 2024

(30) Foreign Application Priority Data
Oct. 23, 2023 (KR) 10-2023-0142289

(51) Int. Cl. F16L 41/14; F16L 41/03

(52) U.S. Cl. CPC F16L 41/14; F16L 41/03

(57) ABSTRACT

A manifold may include a pipe, a nut member at an outer circumferential surface of the pipe, and a manifold body including a port having a concave shape extending into the manifold body from an outer surface of the manifold body, wherein a first portion the nut member is inserted into the port, and the manifold body including a locking part protruding on the outer surface and engaging with a second portion of the nut member to prevent the nut member inserted into the port from being rotated and loosened.

### CROSS-REFERENCE TO RELATED APPLICATIONS

This application claims the benefit of Korean Patent Application No. 10-2023-0142289, filed on Oct. 23, 2023, which application is hereby incorporated herein by reference.

### TECHNICAL FIELD

The present disclosure relates to a manifold.

### BACKGROUND

Recently, crisis awareness of environmental and oil resource depletion has increased, research and development on an electric vehicle, which is an eco-friendly vehicle, has been spotlighted. The electric vehicle includes a plug-in Hybrid Electric Vehicle (PHEV), a Battery Electric Vehicle (BEV), or a Fuel Cell Electric Vehicle (FCEV).

The FCEV may include a fuel cell stack to generate electricity using hydrogen and a hydrogen storage tank to store hydrogen.

The FCEV essentially requires a large-capacity hydrogen storage tank to increase range. The hydrogen storage tank has the shape of a cylinder extending in a width direction of the vehicle, to ensure a longer range of the hydrogen storage tank.

Hydrogen transmitted from the hydrogen storage tank to a fuel cell stack has generally higher pressure, so the FCEV includes a manifold for distributing high-pressure hydrogen. The manifold may include a manifold body including a flow passage and a port to distribute a fluid inside and a pipe connected to the manifold body.

A manifold having a more stable structure is required because an outflow of high-pressure hydrogen gas flowing through the manifold may cause safety accidents.

### SUMMARY

The present disclosure relates to a manifold. Some embodiments of the present disclosure can solve the above-mentioned problems occurring in the prior art while advantages achieved by the prior art are maintained intact.

An embodiment of the present disclosure can provide a manifold capable of improving the air tightness between a pipe and a manifold body.

An embodiment of the present disclosure can provide a manifold capable of preventing a pipe inserted into a manifold body from being released.

Technical problems to be solved by some embodiments of the present disclosure are not limited to the aforementioned problems, and solutions using embodiments for other technical problems not mentioned herein can be clearly understood from the following description by those skilled in the art to which the present disclosure pertains.

According to an embodiment of the present disclosure, a manifold may include a pipe, a nut member at an outer circumferential surface of the pipe, and manifold body including a port having a concave shape extending into the manifold body from an outer surface of the manifold body, wherein a first portion of the nut member is inserted into the port, and the manifold body including a locking part protruding on the outer surface and engaging with a second portion of the nut member to prevent the nut member inserted into the port from being rotated and loosened.

The locking part may include a wedge protruding from the outer surface.

The wedge may be arranged in a circumferential direction of the pipe.

The first portion of the nut member may include a nut fixing part inserted into the port and fixed to the manifold body, wherein the second portion of the nut member may include a nut head part being outside the port to face the locking part, and the wedge may protrude toward the nut head part from the outer surface to fix the nut head part.

The manifold body may include a discharge surface defining a manifold fluid passage configured to discharge a fluid through the port, and a guide surface having a sectional area widened toward outside of the manifold body from the discharge surface.

The pipe may include a pipe body extending in a first direction in which the pipe is inserted into the port, and including the outer circumferential surface of the pipe, and an inflowing part provided at one end portion of the pipe body and inserted into the port to engage the guide surface.

The inflowing part may include an inflowing surface shaped to correspond to the guide surface, and a circumferential rib provided in a second direction that is opposite to the first direction to protrude radially outward of the pipe body.

The inflowing part may include a support surface extending to have a sectional area widened in the first direction from the outer circumferential surface of the pipe body, and a circumferential surface recessed radially inward of the pipe body from the circumferential rib to extend toward the support surface in the second direction.

The nut member may include an inner circumferential surface supporting the outer circumferential surface of the pipe body, a locking surface having a cross-sectional area widened in the first direction from the inner circumferential surface such that the locking surface is locked to the support surface, and a through surface extending in the first direction from the locking surface such that the inflowing part passes through the through surface.

A height (Nh) of the inner circumferential surface in the first direction may be greater than a diameter (D) of the pipe.

A depth (Pd) of the port in a direction in which the nut member is inserted, may be greater than a diameter (D) of the pipe.

According to an embodiment of the present disclosure, a manifold may include a manifold body including a manifold fluid passage and a port formed in a concave shape from an outer surface of the manifold body, a pipe inserted into the port of the manifold body in a first direction, and including a pipe fluid passage fluidly connected to the manifold fluid passage via the port, and a nut member inserted into the port and coupled to the manifold body while supporting the pipe, wherein, a diameter (D) of the pipe and, a depth (Pd) of the port in the first direction may have a ratio (Pd/D) of the depth of the port to the diameter (D) of the pipe equal to or greater than 1.3.

The manifold body may include an inner circumferential surface defining the port, and the depth (Pd) of the port in the first direction may be a length of the inner circumferential surface in the first direction.

The manifold body may include a discharge surface defining the manifold fluid passage, and a guide surface having a sectional area widened toward outside of the manifold body from the discharge surface.

The pipe may include a pipe body extending in the first direction, and including an outer circumferential surface, and an inflowing part provided at one end portion of the pipe body and inserted into the port to the guide surface, and the inflowing part protruding from the outer circumferential surface and radially outward of the pipe body.

The nut member may include an inner circumferential surface configured to support the outer circumferential surface of the pipe body, wherein when a height (Nh) of the inner circumferential surface in the first direction is and the diameter (D) of the pipe may have a ratio (Nh/D) of the height (Nh) of the inner circumferential surface to the diameter (D) of the pipe may be greater than or equal to 1.5.

According to an embodiment of the present disclosure, a manifold system may include a manifold body having a first outer surface, a port extending into the manifold body from the first outer surface, the port having a female-threaded portion with a port diameter, a guide surface extending from a bottom surface of the port into the manifold body, the guide surface having a first conical-shape, and a manifold fluid passage extending from the guide surface into the manifold body, a locking part protruding from the first outer surface, the locking part having a group of wedge-shaped features arranged in a circumferential direction adjacent the port, and a pipe having a pipe body with a first outer diameter having an outer circumferential surface, a flange part having a flange part outer diameter larger than the first outer diameter, an flowing part at a distal end of the pipe at the flange part, the flowing part having a second conical-shape configured to mate with the first conical-shape, the flowing part widening to the flange part outer diameter, the flowing part having a pipe hole exit configured to align with the manifold fluid passage when the flowing part of the pipe is engaged with the guide surface of the manifold body such that the pipe is fluidly coupled to the manifold fluid passage and a nut member having an inner circumferential surface configured to receive and support the outer circumferential surface of the pipe body therein, the nut member having a male-threaded portion on a first nut outer surface, the male-threaded portion being configured to threadedly engage with the female-threaded portion of the port, the nut member having a nut shoulder extending radially outward from the first nut outer surface, the nut shoulder having a shoulder nut width greater than the port diameter of the port, the nut shoulder having a locking surface configured to face and engage the locking part when the nut member is threadedly engaged with the port.

The first outer diameter (D) of the pipe and a depth (Pd) of the port may have a ratio) Pd/D (of the depth (Pd) of the port to the first outer diameter (D) of the pipe equal to or greater than 1.3.

A height (Nh) of the inner circumferential surface of the nut member and the first outer diameter (D) of the pipe may have a ratio) Nh/D (of the height (Nh) of the inner circumferential surface to the first outer diameter (D) greater than or equal to 1.5.

The pipe may have a circumferential rib extending radially outward from the flange part.

### BRIEF DESCRIPTION OF THE DRAWINGS

The above and other features and advantages of the present disclosure can be more apparent from the following detailed description taken in conjunction with the accompanying drawings, in which:

FIG. 1 is a perspective view of a manifold, according to an embodiment of the present disclosure;

FIG. 2 is a perspective view illustrating a port and a locking part of a manifold, according to an embodiment of the present disclosure;

FIG. 3 is a side view of a manifold, according to an embodiment of the present disclosure;

FIG. 4 is a side sectional view of a nut member and a pipe inserted into a manifold body, according to an embodiment of the present disclosure;

FIG. 5 is a bottom perspective view of a nut member, according to an embodiment of the present disclosure;

FIG. 6 is a side view of a nut member, according to an embodiment of the present disclosure;

FIG. 7 is a side sectional view of a pipe inserted into a manifold body, according to an embodiment of the present disclosure;

FIG. 8 is a schematic view illustrating that coupling force of a pipe is distributed into a manifold body, according to an embodiment of the present disclosure; and

FIG. 9 is a cross-sectional view of a manifold, according to an embodiment of the present disclosure.

### DETAILED DESCRIPTION OF ILLUSTRATIVE EMBODIMENTS

Hereinafter, some example embodiments of the present disclosure will be described in detail with reference to accompanying drawings. In adding the reference numerals to the components of each drawing, it can be noted that the identical or equivalent component can be designated by the identical numeral even when they are displayed on other drawings. In addition, in the present disclosure, a detailed description of well-known features or functions can be omitted to not unnecessarily obscure the gist of the present disclosure.

In describing the components of the example embodiment according to the present disclosure, terms such as “first”, “second”, “A”, “B”, “(a)”, “(b)”, and the like, may be used. Such terms can be merely intended to distinguish one component from another component, and such terms do not necessarily limit the nature, sequence, or order of the constituent components. In addition, unless otherwise defined, terms used herein, including technical or scientific terms, can have a same meanings as those generally understood by those skilled in the art to which the present disclosure pertains. Such terms as those defined in a generally used dictionary can be interpreted as having meanings equal to contextual meanings in the relevant field of art, and are not to be interpreted as having ideal or excessively formal meanings unless clearly defined as having such in the present application.

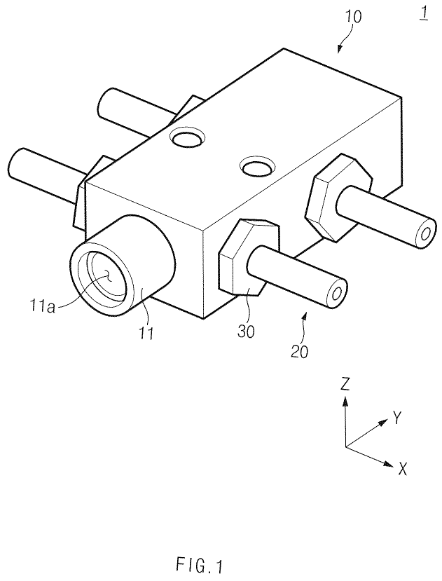

Hereinafter, example embodiments of the present disclosure will be described in detail with reference to FIGS. 1 to 9.

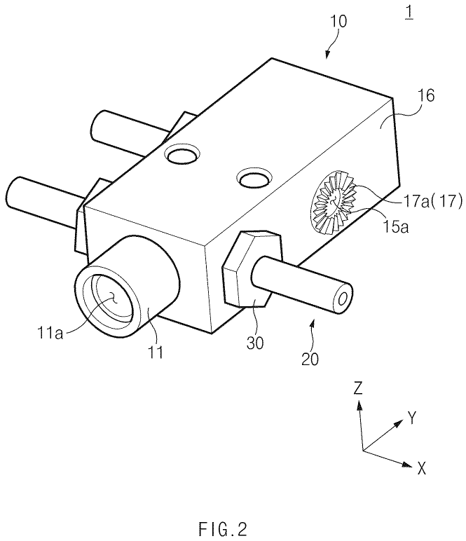

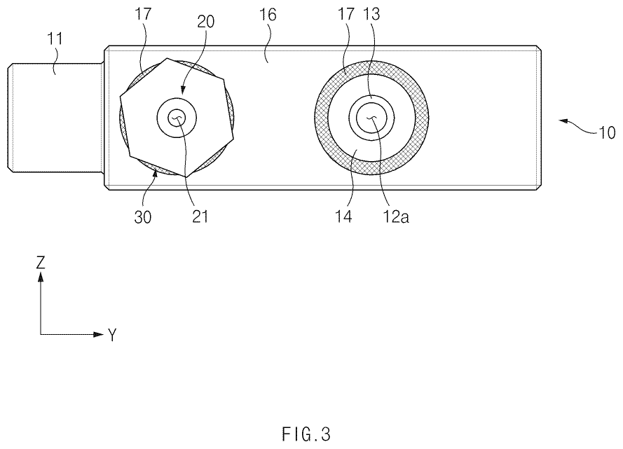

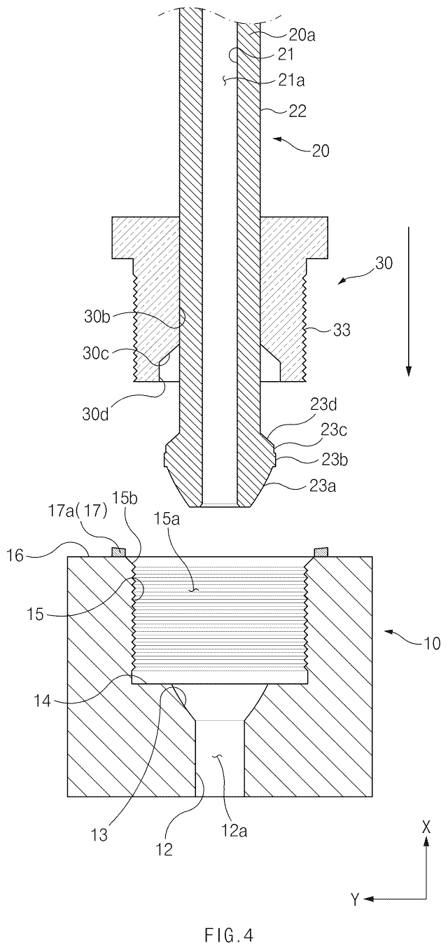

FIG. 1 is a side view of a manifold, according to an embodiment of the present disclosure. FIG. 2 is a perspective view illustrating a port and a locking part of a manifold, according to an embodiment of the present disclosure. FIG. 3 is a side view of a manifold, according to an embodiment of the present disclosure. FIG. 4 is a side sectional view of a nut member and a pipe inserted into a manifold body, according to an embodiment of the present disclosure.

Referring to FIGS. 1 to 4, a manifold 1 may include a manifold body 10 including an inflow communicating part 11 having an inflow hole 11a for inflowing of a fluid. Hereinafter, the fluid may be hydrogen gas, but the present disclosure is not limited thereto.

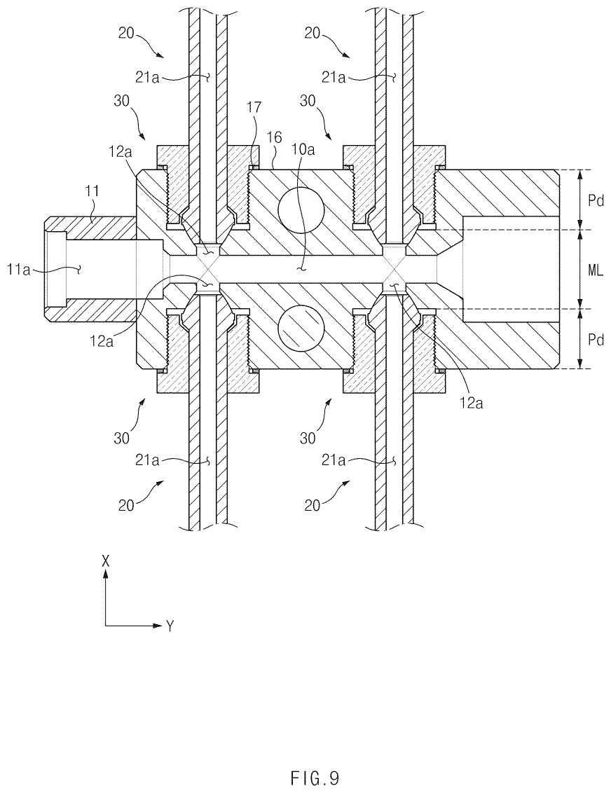

The manifold body 10 may include a distributing fluid passage 10a (see FIG. 9) to distribute a fluid inflowing through the inflow hole 11a and a manifold fluid passage 12a to discharge the fluid inflowing through the distributing fluid passage 10a.

The distributing fluid passage 10a may communicate with the inflow hole 11a such that the fluid flows through the inflow hole 11a, and may communicate with the manifold fluid passage 12a, such that the fluid is discharged through the manifold fluid passage 12a.

The manifold body 10 may include a port 15a provided to discharge the fluid from the manifold fluid passage 12a.

The manifold 1 may include a pipe 20 inserted into each of a plurality of ports 15a to form a pipe fluid passage 21a connected to the manifold fluid passage 12a. The fluid, which flows through manifold fluid passages 12a provided inside the manifold body 10, as the plurality of pipes 20 are inserted into the manifold body 10, may be discharged through the pipes 20 or introduced through the pipes 20.

The manifold 1 may include a nut member 30, which serves as a component to support an outer circumferential surface 22 of each pipe 20, inserted into the port 15a and coupled to the manifold body 10 while supporting the pipe 20.

The manifold body 10 may include the port 15a formed in a concave shape from an outer surface 16 such that the nut member 30 is inserted into the port 15a, and a locking part 17 formed on the outer surface 16 to prevent the nut member 30 inserted into the port 15a from being rotated. The detailed structure of the locking part 17 will be described below.

The manifold body 10 may be screwed with a fixing surface 33, which is an outer circumferential surface of the nut member 30, through an inner circumferential surface 15 defining the port 15a. The nut member 30 may be inserted into the port 15a while supporting the pipe 20, and coupled to the manifold body 10. Accordingly, the nut member 30 may fix the pipe 20 to the port 15a.

In more detail, the manifold body 10 may include a discharge surface 12 extending in a first direction (X direction) toward the port 15a while defining a manifold fluid passage 12a, and a guide surface 13 having a sectional area widened toward the port 15a from one end portion of the guide surface 13, which is adjacent to the port 15a, of the discharge surface 12. In other words, the guide surface 13 may extend to have a sectional area widened toward outside of the manifold body from the discharge surface 12.

The manifold body 10 may include a port surface 14, which extends from the guide surface 13 and radially outward from the virtual central line passing through the center of the manifold fluid passage 12a in the first direction (X direction), the inner circumferential surface 15 extending in the first direction (X direction) from the port surface 14 to surround the port 15a, and an outer surface 16 connected to the inner circumferential surface 15.

The inner circumferential surface 15 may be formed to be provided to have a thread and correspond to the fixing surface 33 of the nut member 30. An inner circumferential guide surface 15b may be provided at a part, which is adjacent to the outer surface 16, of the inner circumferential surface 15. The inner circumferential guide surface 15b may be a surface to guide that the nut member 30 is introduced into the port 15a while being aligned.

The pipe 20 may be inserted into the port 15a in a direction (−X direction) opposite to the first direction. The pipe 20 may include a pipe body 20a which extends in the direction in which the pipe 20 is inserted into the port 15a and includes an outer circumferential surface 22, and an inflowing part 23 provided at one end in the direction in which the pipe body 20a is inserted and inserted into the port 15a toward the guide surface 13.

The outer circumferential surface 22 of the pipe 20 may be an outer circumferential surface of the pipe body 20a, and the inner surface 21 of the pipe 20 may be an inner surface of the pipe body 20a and the inflowing part 23. The outer circumferential surface 22 of the pipe body 20a and the inner surface 21 of the pipe 20 may have a circular sectional surface, when viewed in the direction in which the pipe 20 is inserted into the port 15a. However, the present disclosure is not limited thereto. For example, the outer circumferential surface 22 of the pipe body 20a and the inner surface 21 of the pipe 20 may have a rectangular sectional surface, when viewed in the direction in which the pipe 20 is inserted into the port 15a.

The inflowing part 23 of the pipe 20 may protrude radially outward of the pipe body 20a from the outer circumferential surface of the pipe body 20a and may be inserted into the port 15a toward the guide surface 13.

The inflowing part 23 of the pipe 20 may include an inflowing surface 23a formed to correspond to the guide surface 13 to make contact with the guide surface 13 and a circumferential rib 23b extending in the first direction (X direction) from the inflowing surface 23a while protruding radially outward of the pipe body 20a. The inflowing surface 23a and the circumferential rib 23b may extend in the circumferential direction of the pipe 20.

In this example, the pipe 20 and the manifold body 10 are formed of metal to have a structure of sealing between the inflowing part 23 of the pipe 20 and the guide surface 13, as metal contacts with metal between the inflowing part 23 of the pipe 20 and the guide surface 13. In other words, the inflowing surface 23a of the pipe 20 and the guide surface 13 of the manifold body 10 make contact with each other to cause plastic deformation. Accordingly, as fastening torque having stronger strength is distributed into the manifold body 10 such that the manifold 1 ensures the fastening torque. Accordingly, the air tightness may be improved between the pipe 20 and the manifold body 10.

The inflowing part 23 of the pipe 20 may include a support surface 23d having a sectional area increased in the opposite direction (−X direction) to the first direction (X direction) from the outer circumferential surface 22 of the pipe body 20a and a circumferential surface 23c which extends in the opposite direction (−X direction) to the first direction and is recessed radially inward of the pipe body 20a from the circumferential rib 23b. In other words, the circumferential surface 23c may be recessed radially inward of the pipe body 20a from the circumferential rib 23b to extend toward the support surface 23d in the first direction (X direction).

The support surface 23d and the circumferential surface 23c may protrude radially outward of the pipe body 20a from the outer circumferential surface 22 of the pipe body 20a to support the circumferential rib 23b.

The inflowing part 23 of the pipe 20 may be formed to be caught by the nut member 30 while the nut member 30 is fixed to the manifold body 10 to prevent the pipe 20 from being withdrawn from the port 15a in the first direction (X direction).

The nut member 30 may include an inner circumferential surface 30b which supports the outer circumferential surface 22 of the pipe body 20a, a locking surface 30c extending to have a cross-sectional area increased from the inner circumferential surface 30b in the direction in which the nut member 30 is inserted into the port 15a, such that the support surface 23d of the pipe 20 is locked to the locking surface 30c, and a through surface extending from the locking surface 30c in the opposite direction (−X direction) to the first direction (X direction) such that the inflowing part 23 passes through the through surface 30d.

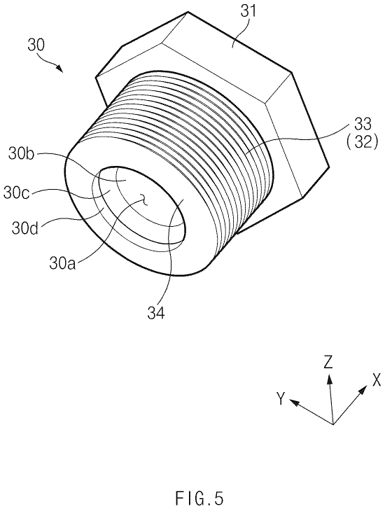

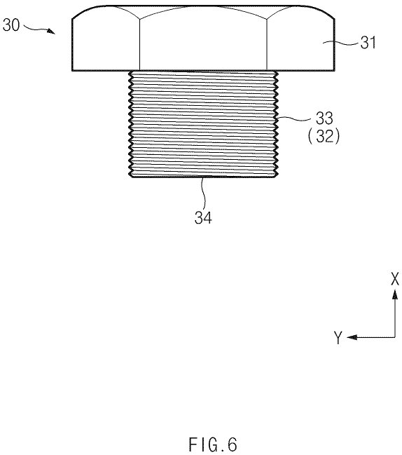

FIG. 5 is a bottom perspective view of a nut member, according to an embodiment of the present disclosure. FIG. 6 is a side view of a nut member, according to an embodiment of the present disclosure.

Referring to FIGS. 5 and 6, the nut member 30 may include a nut fixing part 32 inserted into the port 15a (see FIG. 4) and fixed to the manifold body 10, and a nut head part 31 outside the port 15a to face the locking part 17.

The nut member 30 may include a nut hole 30a provided inside the nut head part 31 and the nut fixing part 32 such that the pipe body 20a is inserted into the nut hole 30a.

The nut fixing part 32 may include a fixing surface 33 extending in the circumferential direction and provided a thread corresponding to the inner circumferential surface 15 of the port 15a, and an insertion surface 34 inserted into the port 15a to face the port surface 14.

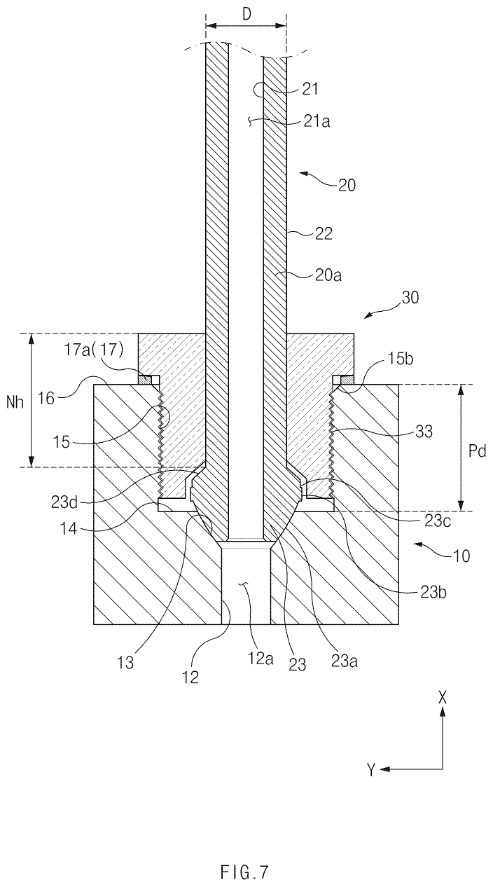

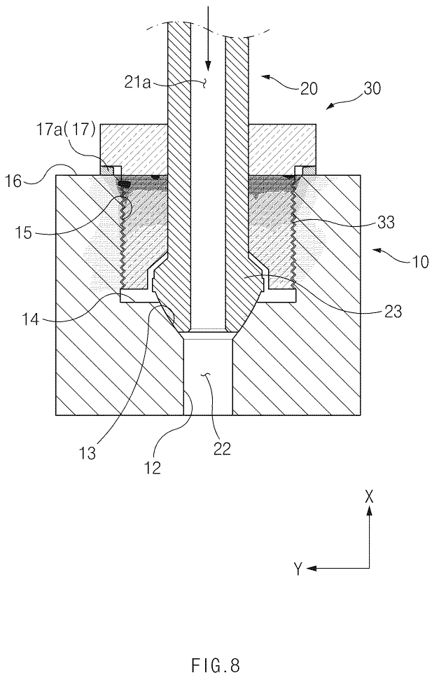

FIG. 7 is a side sectional view of a pipe inserted into a manifold body, according to an embodiment of the present disclosure. FIG. 8 is a schematic view illustrating that coupling force of a pipe is distributed into a manifold body, according to an embodiment of the present disclosure. FIG. 9 is a cross-sectional view of a manifold, according to an embodiment of the present disclosure.

Referring to FIGS. 2 and 7 to 9, in the structure of the manifold 1 according to one embodiment of the present disclosure, as described above, the pipe 20 and the nut member 30 are inserted into the port 15a, and the nut member 30 is coupled to the manifold body 10, thereby blocking the pipe 20 from being withdrawn from the port 15a, such that more stable support may be made.

In such a structure, the nut member 30 and the pipe 20 are inserted into the port 15a. Accordingly, when compared to the structure in which the pipe 20 is coupled at an outside of the port 15a, the productivity of the manifold 1 may be improved, because the insertion position of the pipe 20 and the nut member 30 into the port 15a may be guided.

The coupling force between the manifold body 10, the pipe 20, and the nut member 30 of the manifold 1 may be important in terms of the structural stability of the manifold 1.

For example, the manifold 1 may be a component mounted inside a vehicle to distribute hydrogen gas from a hydrogen storage tank (not shown) or to supply hydrogen gas to the hydrogen storage tank.

For manifold 1 to distribute a high-pressure fluid, such as hydrogen gas, which may be increased up to 1,050 bars, the airtight performance of the manifold body 10 and the pipe 20 is required. Due to the environment in which the manifold 1 is mounted inside the vehicle, the structure to support higher fastening torque may be needed.

When the port 15a of the manifold body 10 is neither formed to protrude from the outer surface 16 nor the nut member 30 is inserted into the port 15a, the outer diameter of the port 15a may be changed due to the repeated coupling between the pipe 20 and the nut member 30, and the manifold body 10, which may cause relatively difficulties in assembling the manifold body 10, the pipe 20, and the nut member 30, thereby weakening durability and usability.

To solve such a problem, according to the present disclosure, the structure may be provided in which the port 15a formed in a concave shape from the outer surface 16 of the manifold body 10 may be provided, and the position of the pipe 20 is fixed through the nut member 30 as the pipe 20 is inserted toward the port 15a.

To more stably support the pipe 20 to the port 15a, the depth ‘Pd’ of the port 15a, in the direction in which the nut member 30 is inserted, may be provided to be greater than the diameter ‘D’ of the pipe 20. More specifically, the ratio ‘Pd/D’ of the depth ‘Pd’ of the port 15a in the first direction (X direction) to the diameter ‘D’ of the pipe 20 may be greater than or equal to 1.3.

The depth ‘Pd’ of the port 15a in the first direction (X direction) may be the height of the inner circumferential surface 15 in the first direction (X direction) of the manifold body 10. When the depth ‘Pd’ of the port 15a in the first direction (X direction) is greater than or equal to 1.3 times the diameter ‘D’ of the pipe 20, the pipe 20 inserted into the port 15a may be more stably coupled to the manifold body 10 while being supported by the nut member 30.

Such a structure may prevent the structural deformation of the nut member 30 and the pipe 20 inserted into the port 15a even in the environment in which the nut member 30 and the pipe 20 are mounted in the vehicle and repeatedly receive the fastening torque of about 40 N·m. In this case, the fastening torque of about 40 N·m may be applied because a more strict environment is required during the driving, even though the fastening torque of 30 N·m is required such that the fluid is prevented from flowing out through the space between the manifold body 10 and the pipe 20 under the fluid pressure of 700 bar.

Further, for the nut member 30 to more stably support the pipe 20, the height ‘Nh’ of the inner circumferential surface 30b in the direction in which the nut member 30 is inserted into the port 15a may be greater than the diameter D of the pipe 20. In more detail, the ratio ‘Nh/D’ of the height Nh of the inner circumferential surface 30b in the direction, in which the nut member 30 is inserted into the port 15a, may be equal to or greater than 1.5.

The height Nh of the inner circumferential surface 30b in the direction, in which the nut member 30 is inserted into the port 15a, may refer to the contact height between the nut member 30 and the pipe body 20a. When the height Nh of the inner circumferential surface 30b in the opposite direction (−X direction) to the first direction is equal to or greater than 1.5 times the diameter D of the pipe 20, the pipe 20 inserted into the port 14a is supported by the nut member 30, such that more stable coupling is maintained.

According to the above principle, according to an embodiment of the present disclosure, as the port 15a formed to be concave from the outer surface 16 of the manifold body 10, and the structure of the nut member 30 and the pipe 20 inserted into the port 15a are more stably coupled to each other to improve the durability of the manifold 1. Accordingly, the component of the manifold 1 may be prevented from being disassembled even in the condition of stronger fastening torque.

Together with such a structure, a locking part 17 including a wedge 17a protruding from the outer surface 16 may be formed on the outer surface of the manifold body 10. The locking part 17 may be formed on the outer surface 16 to surround each port 15a. Wedges 17a may be arranged in a circumferential direction of the pipe 20 in the state that the pipe 20 is inserted into the port 15a.

The wedge 17a may protrude from the outer surface 16 toward the nut head 31 to fix the nut head 31 (see FIG. 5). Since the wedge 17a may be formed to be caught on the bottom surface of the nut head 31, the nut head 31 caught on the wedge 17a may be prevented from rotating about the center of the nut hole 30a.

According to this structure, an opposite end portion of the pipe body 20a may be relatively free to move, as compared to the inflowing part 23, as long as the inflowing part 23 provided at one end portion of the pipe body 20a is fixed to the port 15a of the manifold body 10, and the opposite end portion of the pipe body 20a is not supported by an additional component.

In particular, a portion, which is closer to an opposite end portion of the pipe body 20a rather than the inflowing part 23, of the pipe 20 may move in the second direction (Y direction) or the third direction (Z direction) perpendicular to the first direction (−X direction) or may rotate about the first direction (−X direction) under the driving environment.

In this case, as the pipe 20 freely moves, that is, the pipe 20 or the nut member 30 is influenced by external force, the inflowing part 23 can be separated from the guide surface 13. Accordingly, the fluid including higher-pressure hydrogen gas may be flow out of the port 15a by passing through a space between the guide surface 13 and the inflowing surface 23a through the manifold fluid passage 12a of the manifold body 10. Accordingly, a safety accident may be caused.

To prevent this, the wedge 17a is provided to be caught by the bottom surface of the nut head 31, and the rotation of the nut head 31 may be prevented by using the frictional force generated between the wedge 17a and the bottom surface of the nut head 31, thereby preventing the nut member 30 and the pipe 20 supported by the nut member 30 from being released.

Through the above-described structure, as illustrated in FIG. 8, the axial force may be transmitted to the manifold body 10 in the longitudinal direction of the pipe 20. In more detail, a portion of the axial force received through the inflowing part 23 as the pipe 20 is inserted into the port 15a may be transmitted to the manifold body 10 through the guide surface 13 or transmitted to the manifold body 10 through the nut member 30 being radially outward of the inflowing part 23. Accordingly, the axial force of the pipe 20 may be uniformly transmitted to the outside of the pipe 20 radially. Accordingly, the pipe 20 may be more stably supported. Accordingly, the structural stability of the present disclosure may be verified.

As illustrated in FIG. 9, as compared to the structure in which the port 15a of the manifold body 10 is provided outside the manifold body 10 and is inserted, the distance ML between a pair of ports 15a facing each other in opposite directions may be relatively shorter through the structure according to an embodiment of the present disclosure.

Due to the above structure, there may be required a process of boring an inner part of the manifold body 10 with the length ML of the manifold fluid passage 12a corresponding to the distance ML between one pair of ports 15a facing each other. Such process can improve the productivity.

According to an embodiment of the present disclosure, the gas sealing between the pipe and the manifold body may be improved, thereby preventing safety accident.

According to an embodiment of the present disclosure, as the nut member and the pipe are inserted into the manifold body and assembled to the manifold body to form the assembled structure, deformation of the manifold body can be prevented.

According to an embodiment of the present disclosure, the pipe and the nut member may be prevented from being released even during driving, due to the structure of the locking part formed on the outer surface of the manifold body.

The above description illustrates some example embodiments of the present disclosure, and various modifications and modifications may be made by one skilled in the art without departing from the claimed scope of the present disclosure.

Therefore, the example embodiments of the present disclosure are provided to explain the spirit and scope of the present disclosure, but not to necessarily limit them, so that the spirit and scope of the present disclosure is not necessarily limited by the example embodiments. The scope of the present disclosure can be construed on the basis of the accompanying claims, and technical ideas within scopes equivalent to the claims can be included in scopes of the present disclosure.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A manifold comprising:
a pipe;
a nut member at an outer circumferential surface of the pipe; and
a manifold body including a port having a concave shape extending into the manifold body from an outer surface of the manifold body, wherein a first portion of the nut member is inserted into the port, and the manifold body including a locking part protruding on the outer surface and engaging with a second portion of the nut member to prevent the nut member inserted into the port from being rotated and loosened.

2. The manifold of claim 1, wherein the locking part includes a wedge protruding from the outer surface.

3. The manifold of claim 2, wherein the wedge is arranged in a circumferential direction of the pipe.

4. The manifold of claim 2, wherein the first portion of the nut member includes a nut fixing part inserted into the port and fixed to the manifold body, wherein the second portion of the nut member includes
a nut head part positioned outside the port to face the locking part, and
wherein the wedge protrudes toward the nut head part from the outer surface to fix the nut head part.

5. The manifold of claim 1, wherein the manifold body includes:
a discharge surface defining a manifold fluid passage configured to discharge a fluid through the port; and
a guide surface having a sectional area widened toward outside of the manifold body from the discharge surface.

6. The manifold of claim 5, wherein the pipe includes:
a pipe body extending in a first direction in which the pipe is inserted into the port, and including the outer circumferential surface of the pipe; and
an inflowing part provided at one end portion of the pipe body and inserted into the port to engage the guide surface.

7. The manifold of claim 6, wherein the inflowing part includes:
an inflowing surface shaped to correspond to the guide surface; and
a circumferential rib provided in a second direction, the second direction being opposite to the first direction, to protrude radially outward of the pipe body.

8. The manifold of claim 7, wherein the inflowing part includes:
a support surface extending to have a sectional area widened in the first direction from the outer circumferential surface of the pipe body; and
a circumferential surface recessed radially inward of the pipe body from the circumferential rib to extend toward the support surface in the second direction.

9. The manifold of claim 8, wherein the nut member includes:
an inner circumferential surface supporting the outer circumferential surface of the pipe body;
a locking surface having a cross-sectional area widened in the first direction from the inner circumferential surface such that the locking surface is locked to the support surface; and
a through surface extending in the first direction from the locking surface such that the inflowing part passes through the through surface.

10. The manifold of claim 9, wherein a height (Nh) of the inner circumferential surface in the first direction is greater than a diameter (D) of the pipe.

11. The manifold of claim 1, wherein a depth (Pd) of the port in a direction in which the nut member is inserted, is greater than a diameter (D) of the pipe.

12. A manifold comprising:
a manifold body including a manifold fluid passage and a port formed in a concave shape from an outer surface of the manifold body;
a pipe inserted into the port of the manifold body in a first direction, and including a pipe fluid passage fluidly connected to the manifold fluid passage via the port; and
a nut member inserted into the port and coupled to the manifold body while supporting the pipe,
wherein a diameter (D) of the pipe and a depth (Pd) of the port in the first direction has a ratio) Pd/D (of the depth (Pd) of the port to the diameter (D) of the pipe equal to or greater than 1.3.

13. The manifold of claim 12, wherein the manifold body includes an inner circumferential surface defining the port, and wherein the depth (Pd) of the port in the first direction is a length of the inner circumferential surface in the first direction.

14. The manifold of claim 12, wherein the manifold body includes:
a discharge surface defining the manifold fluid passage; and
a guide surface having a sectional area widened toward outside of the manifold body from the discharge surface.

15. The manifold of claim 14, wherein the pipe includes:
a pipe body extending in the first direction, and including an outer circumferential surface; and
an inflowing part provided at one end portion of the pipe body and inserted into the port to the guide surface, and the inflowing part protruding from the outer circumferential surface and radially outward of the pipe body.

16. The manifold of claim 15, wherein the nut member includes an inner circumferential surface configured to support the outer circumferential surface of the pipe body, and
wherein a height (Nh) of the inner circumferential surface in the first direction and the diameter (D) of the pipe has a ratio) Nh/D (of the height (Nh) of the inner circumferential surface to the diameter (D) of the pipe greater than or equal to 1.5.

17. A manifold system comprising:
a manifold body having a first outer surface, a port extending into the manifold body from the first outer surface, the port having a female-threaded portion with a port diameter, a guide surface extending from a bottom surface of the port into the manifold body, the guide surface having a first conical-shape, and a manifold fluid passage extending from the guide surface into the manifold body, a locking part protruding from the first outer surface, the locking part having a group of wedge-shaped features arranged in a circumferential direction adjacent the port;
a pipe having a pipe body with a first outer diameter having an outer circumferential surface, a flange part having a flange part outer diameter larger than the first outer diameter, an flowing part at a distal end of the pipe at the flange part, the flowing part having a second conical-shape configured to mate with the first conical-shape, the flowing part widening to the flange part outer diameter, the flowing part having a pipe hole exit configured to align with the manifold fluid passage when the flowing part of the pipe is engaged with the guide surface of the manifold body such that the pipe is fluidly coupled to the manifold fluid passage; and
a nut member having an inner circumferential surface configured to receive and support the outer circumferential surface of the pipe body therein, the nut member having a male-threaded portion on a first nut outer surface, the male-threaded portion being configured to threadedly engage with the female-threaded portion of the port, the nut member having a nut shoulder extending radially outward from the first nut outer surface, the nut shoulder having a shoulder nut width greater than the port diameter of the port, the nut shoulder having a locking surface configured to face and engage the locking part when the nut member is threadedly engaged with the port.

18. The system of claim 17, wherein the first outer diameter (D) of the pipe and a depth (Pd) of the port has a ratio) Pd/D (of the depth (Pd) of the port to the first outer diameter (D) of the pipe equal to or greater than 1.3.

19. The system of claim 18, wherein a height (Nh) of the inner circumferential surface of the nut member and the first outer diameter (D) of the pipe has a ratio) Nh/D (of the height (Nh) of the inner circumferential surface to the first outer diameter (D) greater than or equal to 1.5.

20. The system of claim 19, wherein the pipe has a circumferential rib extending radially outward from the flange part.
